(19) United States
(12) Patent Application Publication
(10) Pub. No.: US 2004/0190983 A1
(43) Pub. Date: Sep. 30, 2004

(54) Gas cylinder clamp

(76) Inventor: Kenneth E. Hamilton, South Woodstock, CT (US)

Correspondence Address: LIEBERMAN & BRANDSDORFER, LLC, 12221 MCDONALD CHAPEL DRIVE, GAITHERSBURG, MD, 20878, US

(21) Appl. No.: 10/400,495

(22) Filed: Mar. 28, 2003

(51) Int. Cl. F16B 7/04

(52) U.S. Cl. 403/313

(57) ABSTRACT

The clamp has two semi-circular sections that are adapted to be placed around an exterior surface of a gas cylinder and/or an associated shaft. Each section has a set of mirror imaged apertures adapted to receive securing elements to hold the clamp in a set position. In addition, a fastening element is provided to control delivery of tension to the cylinder, which controls extension of the shaft in communication with the cylinder.

### BACKGROUND OF THE INVENTION

1. Technical Field

This invention relates to a clamp for locking a gas cylinder in a set position. More specifically, the clamp may be adjusted in multiple directions to properly set the clamp in an appropriate position for control of the gas cylinder.

2. Description Of The Prior Art

Different devices for controlling movement of a gas cylinder are known in the art. For example, storm doors commonly include a shaft that connects the door to the wall opening that the door is intended to close. The gas cylinder has a shaft that is housed within the cylinder. When the cylinder holds tension, the shaft extends out of the cylinder a distance proportional to the tension. When the tension is released from the cylinder, the cylinder pulls the shaft into the confines of the cylinder. In effect, the cylinder functions to direct movement of a connected object as well as dampen the affect of movement of the object by extending or releasing tension held on the shaft.

In order to set the length of the shaft, the cylinder may include a mechanical slide that may be adjusted along the length of the shaft. Movement of the slide to a set position sets the length of the shaft. Mechanical slide mechanisms associated with gas cylinders are commonly found on doors, as well as other objects that may benefit from the dampening effect provided by the cylinder. However, there are drawbacks associated with the mechanical slide mechanisms. First, the slide must be placed on the shaft in conjunction with placement of the cylinder. Second, the slide mechanism has a tendency to move along the length of the shaft and is not capable of being firmly secured to the shaft or the gas cylinder. Accordingly, the slide mechanism is not reliable as a secure mechanism to hold the shaft in a set position relative to the cylinder.

U.S. Pat. No. 4,815,163 to Simmons is an example of a lock apparatus for a gas cylinder associated with a storm door. The apparatus includes a pneumatic or hydraulic-type damper and a reciprocating rod. A cylinder bracket is provided to secure the cylinder and rod to a door. A clamp is provided with a latching recess and a cantilever. As pressure is applied to the latching recess, the cantilever is pivoted by means of a detent lever to engage the cylinder and to lock the cylinder in a specific orientation. However, the bracket of Simmons is used as an element to communicate with the cylinder indirectly through the detent lever, and not as an element to communicate directly with cylinder. Accordingly, Simmons requires additional mechanical elements to control displacement of the detent lever.

Accordingly, there is a need to control positioning of a gas cylinder that requires few mechanical elements and that can control displacement of the gas cylinder apparatus through direct communication.

### SUMMARY OF THE INVENTION

This invention comprises a clamp adapted to secure to a gas cylinder to control delivery of tension to the cylinder.

In a first aspect of the invention, a cylindrical collar is formed from a first half and a second half. The first and second halves each have a first section with an open center region, an exterior edge, an interior edge, and a first surface adapted to extend between the exterior and interior edges. The first section has a proximal end and a distal end. A first aperture extends through the first surface adjacent to the proximal end, a second aperture extends through the first surface adjacent to the distal end, and a third aperture extends through the first surface from the exterior edge to the interior edge. In addition, a first securing element is adapted to be placed through the first aperture of the first half to the first aperture of the second half. Similarly, a second securing element is adapted to be placed through the second aperture of the first half to the second aperture of the second half. A third securing element is adapted to extend through the third aperture of the first half. Rotation of the third securing element in a clockwise direction preferably places a shaft in communication with the cylinder in tension. Similarly, rotation of the third securing element in a counter-clockwise direction preferably releases tension from the shaft. The clamp may also include a second section on said first and second halves, wherein the second section has an open center region, an exterior edge, an interior edge, and a second surface adapted to extend between the exterior and interior edges. The first and second sections are preferably concentrically positioned. The second section is preferably placed around an exterior surface of the cylinder and the first section is preferably placed around a shaft in communication with the cylinder.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a front view of a first half section of the clamp.

FIG. 2 is a top view of the assembled clamp.

FIG. 3 is a side view of first half section and the second half section assembled.

FIG. 4 is an exploded view of the first and second halves of the clamp with the fastening elements according to the preferred embodiment of this invention, and is suggested for printing on the first page of the issued patent.

### DESCRIPTION OF THE PREFERRED EMBODIMENT

### Overview

The invention relates to a clamp for a shaft of a gas cylinder. The clamp is provided independent of the cylinder and may be attached to any shaft associated with a gas cylinder, and/or the gas cylinder. The clamp is not tied into the cylinder in such a way that requires the securing of the clamp to the shaft prior to or in conjunction with placement of the cylinder in communication with the shaft. Accordingly, the clamp is universally adaptable to secure to a secondary surface.

### Technical Details

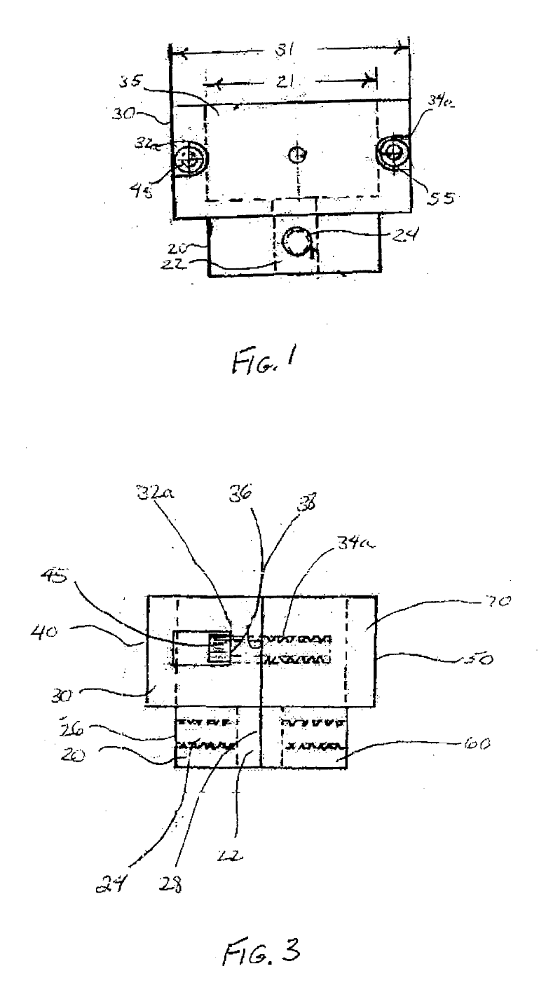

The clamp has two halves. FIG. 1 is a front view of a first half 40 of the clamp. As seen in FIG. 1, the first half 40 of the clamp 10 includes a first section 20 and a second section 30. The first section 20 and the second section 30 are concentric, with the first section 20 having a diameter 21 smaller than the diameter 31 of the second section 30. The first section 20 has a semi-circular shape which forms an opening 22 when the first half section 40 is secured to the second half section 50. During placement of the clamp 10 adjacent to an air cylinder (not shown), the semi-circular shape that forms the opening 22 is adapted to be placed around an external surface of a shaft. The first section 20 of the first half 40 of the clamp 10 also has an aperture 24 that extends from an exterior wall surface 26 to an interior wall surface 28. The aperture 24 is perpendicular to the formed opening 22. In addition, the aperture 24 has a threaded wall surface and is adapted to receive a fastening element (not shown) therein. When the fastening element is placed in the aperture 24 it extends from the exterior wall surface 26 toward the interior wall surface 28, with a portion remaining outside of the exterior wall surface 26. As the fastening element is turned in a clockwise direction, the element extends further into the aperture 24 toward the interior wall surface 28.

The second section 30 of the first half 40 of the clamp 10 has a set of secondary apertures 32a and 34a, located on diametrically opposite sides of the section. The apertures 32a and 34a each extend from an exterior wall surface 36 toward an interior wall surface 38. Each of the apertures 32a, 34a is adapted to receive a securing element 45, 55, respectively, therein. The second section 30 has a semi-circular shape that forms an opening 35 that is adapted to be placed around an external surface of the gas cylinder. Prior to formation of the clamp, the first half 40 of the clamp 10 must be held adjacent to the gas cylinder with the first section 20 adjacent to the shaft and the second section 30 adjacent to the gas cylinder. Similarly, the second half 50 of the clamp 10 must be placed adjacent to the gas cylinder with exterior wall surfaces parallel to exterior wall surfaces of the first half 40.

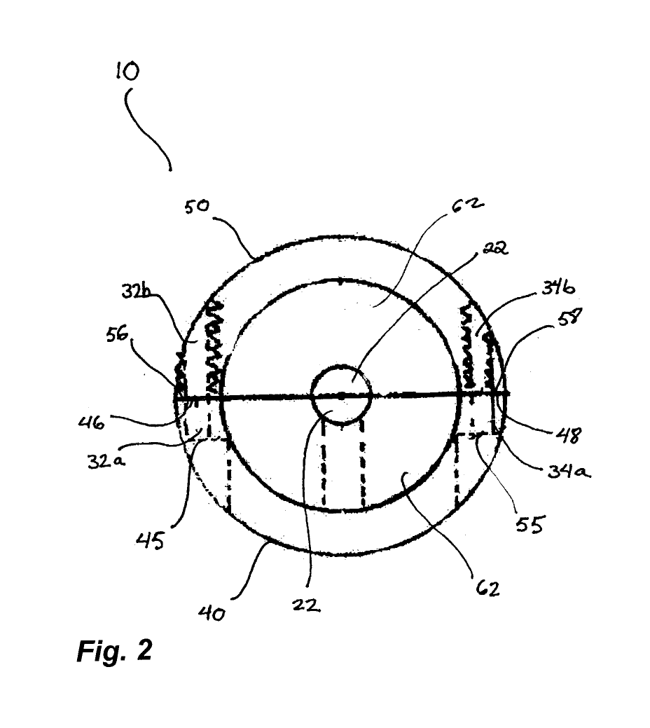

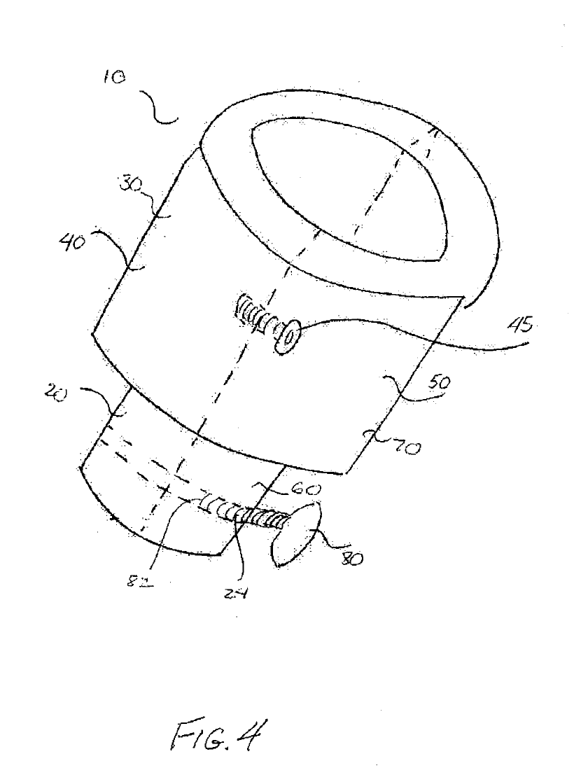

FIG. 2 is a top view of the clamp 10 showing the first half 40 secured to the second half 50. As shown, the first half 40 has a set of apertures 32a and 42a that are adapted to align with corresponding apertures 32b and 42b of the second half 50 of the clamp 10. The second half 50 of the clamp is nearly identical to the first half 40 of the clamp. Similar to the first half 40, the second half 50 includes a first section 60 and a second section 70, as shown in FIG. 3, which are concentric. The first section 60 has a diameter 61 smaller than the diameter 71 of the second section 70. The first section 60 has a semi-circular shape which forms opening 35 when the second half 50 is secured to the first half section 40. During placement of the clamp 10 adjacent to an air cylinder (not shown), the semi-circular shape that forms the opening 35 is adapted to be placed around an external surface of a shaft.

As shown in FIG. 2, the semi-circular shapes 22, 62 of the first and second halves, form an aperture 35 that is adapted to receive the shaft of the gas cylinder. Similarly, when the first half 40 and the second half 50 are placed in an adjacent relationship the exterior wall surfaces 46, 48 of the second section 30 of the first half 40 becomes aligned with the exterior wall surfaces 56, 58 of the second section 70 of the second half 50, respectively. As the exterior wall surfaces align, aperture 32a aligns with aperture 32b, and aperture 34a aligns with aperture 34b. Fastening element 45 is placed in the aperture 32a and is rotated clockwise until it enters aligned aperture 32b and is received in the threaded walls of aperture 32b. Similarly, fastening element 55 is placed in aperture 34a and is rotated clockwise until it enters aligned aperture 34b. Both of the fastening elements are rotated until the two halves 40, 50 form the clamp and surround the cylinder in a secure position, i.e. without sliding across the exterior body of the cylinder.

FIG. 3 is a side view of the first and second halves 40, 50 of the clamp 10, together with the fastening element 45 extending from aperture 32a to aperture 32b. On the side not shown, there is a similar fastening element extending from aperture 34a to aperture 34b. The first and second halves 40 and 50, respectively, are adapted to be fastened together by a set of fastening elements 45 and 55 (not shown) to form a clamp 10 with the exterior surfaces 46, 56 and 48, 58 adjacently aligned.

FIG. 4 is an exploded view of both halves 40, 50 of the clamp being placed around the exterior surface of the shaft. As shown in FIGS. 1 and 2, the first half 40 of the clamp 10 is adapted to receive a fastening element 80 in aperture 24 that is perpendicular to opening 22. Following formation of the clamp around the exterior surface of the cylinder and associated shaft, the operator may rotate the fastening element 80 in order to increase tension or to reduce tension. For example, rotation of the fastening element in a clockwise direction, will cause the fastening element to extend further into an interior area of the first section 20 of the first half 40 of the clamp. This enables a distal end 82 of the fastening element to contact an exterior surface of the shaft and to cause tension therein. It is the tension transmitted from the fastening element 80 to the shaft that prevents the shaft from rotating to full extension in relation to the cylinder. Similarly, by rotating the fastening element 80 in a counter-clockwise direction, tension to the shaft is mitigated and enables the shaft to rotate with respect to the cylinder. Accordingly, once the clamp is formed and placed around the cylinder and associated shaft, rotation of the fastening element controls the extension of the shaft with relation to the cylinder.

### Advantages Over The Prior Art

The clamp is designed to be assembled to a shaft in communication with a gas cylinder. The secondary apertures enable the clamp to be assembled and secured to any cylinder and associated shaft, and following the step of assembling and securing the clamp the fastening element may be rotated to control tension in the cylinder. Similarly, the clamp may be removed from the cylinder and associated shaft by releasing tension in the cylinder followed by releasing the securing elements in the secondary apertures. The clamp has a lot of maneuverability and does not require assembling the clamp with the cylinder. Rather, the clamp may be secured to or released from the cylinder as often as deemed appropriate.

### Alternative Embodiments

It will be appreciated that, although specific embodiments of the invention have been described herein for purposes of illustration, various modifications may be made without departing from the spirit and scope of the invention. In particular, the clamp may be designed to include the first and second halves of the clamp with each half limited to the elements of the first section. This would enable the clamp to be secured to the shaft without requiring communication with the cylinder. As the tightening element is rotated, the clamp controls extension of the shaft by either increasing or releasing the tension held by the tightening element on the shaft. Accordingly, the scope of protection of this invention is limited only by the following claims and their equivalents.

I claim:

1. A clamp for use in association with a gas cylinder comprising:
a cylindrical collar having a first half and a second half, the first half and the second half of the collar each having a semi-circular shape;
said first half and said second half of said collar having a first section with an open center region, an exterior edge, an interior edge, and a first surface adapted to extend between said exterior edge and said interior edge;
said first section having a proximal end and a distal end;
a first aperture adapted to extend through said first surface adjacent to said proximal end;
a second aperture adapted to extend through said first surface adjacent to said distal end;
a third aperture adapted to extend through said first surface from said exterior edge to said interior edge;
a first securing element adapted to be placed through said first aperture of said first half to said first aperture of said second half;
a second securing element adapted to be placed through said second aperture of said first half to said second aperture of said second half;
a third securing element adapted to extend through said third aperture of said first half.

2. The clamp of claim 1, wherein rotation of said third securing element in a clockwise direction places a shaft in communication with said cylinder in tension.

3. The clamp of claim 1, wherein rotation of said third securing element in a counter-clockwise direction release tension from a shaft in communication with said cylinder.

4. The clamp of claim 1, further comprising said first half and said second half of said collar having a second section with an open center region, an exterior edge, an interior edge, and a second surface adapted to extend between said exterior edge and said interior edge.

5. The clamp of claim 4, wherein said first section and said second section are concentrically positioned with a sloped surface adapted to extend from said interior edge of said distal end of said first section to said interior edge of said proximal end of said second section;

6. The clamp of claim 5, further comprising a first aperture adapted to extend through said second surface adjacent to said proximal end, and a second aperture adapted to extend through said second surface adjacent to said distal end.

7. The clamp of claim 6, wherein said second section is adapted to be placed around an exterior surface of said cylinder and said first section is adapted to be placed around a shaft in communication with said cylinder.

8. The clamp of claim 1, wherein said interior edge is placed adjacent to a shaft in communication with said cylinder upon fastening said securing elements of said first half and said second half.

9. The clamp of claim 1, wherein said open region is adapted to receive a shaft in communication with said cylinder.

10. A gas cylinder clamp comprising:
a cylindrical collar having a first half and a second half, the first half and the second half of the collar each having a semi-circular shape;
said first half and said second half of said collar having a first section with an open center region, an exterior edge, an interior edge, and a first surface adapted to extend between said exterior edge and said interior edge;
said first section having a proximal end and a distal end;
a first aperture adapted to extend through said first surface adjacent to said proximal end;
a second aperture adapted to extend through said first surface adjacent to said distal end;
a third aperture adapted to extend through said first surface from said exterior edge to said interior edge;
a first securing element adapted to be placed through said first aperture of said first half to said first aperture of said second half;
a second securing element adapted to be placed through said second aperture of said first half to said second aperture of said second half;
a third securing element adapted to extend through said third aperture of said first half; and
said first half and said second half of said collar having a second section with an open center region, an exterior edge, an interior edge, and a second surface adapted to extend between said exterior edge and said interior edge; and
said first section is adapted to be placed around an exterior surface of said cylinder, and said second section is adapted to be placed around an exterior surface of a shaft in communication with said cylinder.

11. The clamp of claim 10, wherein rotation of said third securing element in a clockwise direction places said shaft in tension.

12. The clamp of claim 10, wherein rotation of said third securing element in a counter-clockwise direction releases tension from said shaft.
